(19) United States
(12) Patent Application Publication
(10) Pub. No.: US 2022/0351455 A1
(43) Pub. Date: Nov. 3, 2022

(54) METHOD OF PROCESSING IMAGE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventor: Di WANG, Beijing (CN)

(73) Assignee: BEIJING BAIDU NETCOM SCIENCE TECHNOLOGY CO., LTD., Beijing (CN)

(21) Appl. No.: 17/864,898

(22) Filed: Jul. 14, 2022

(30) Foreign Application Priority Data
Jul. 21, 2021 (CN) 202110827883.3

(51) Int. Cl. G06T 15/04; G06T 7/529; G06T 7/30

(52) U.S. Cl. CPC G06T 15/04; G06T 7/529; G06T 7/30; G06T 2207/20084

(57) ABSTRACT

A method of processing an image, an electronic device, and a storage medium. The method includes: determining a shape parameter, a texture parameter and a static wrinkle parameter for an object according to an input image; reconstructing a coarse reconstructed shape for the object by using the shape parameter, and computing a coarse reconstructed texture map for the object by using the texture parameter; determining a fine reconstructed shape and a fine reconstructed texture map according to the static wrinkle parameter, the shape parameter and the texture parameter; and performing a rendering process based on the coarse reconstructed shape, the coarse reconstructed texture map, the fine reconstructed shape and the fine reconstructed texture map, so as to obtain a coarse reconstructed image and a fine reconstructed image for the input image.

This application claims priority to Chinese Patent Application No. 202110827883.3, filed on Jul. 21, 2021, the entire contents of which are incorporated in its entirety by reference.

### TECHNICAL FIELD

The present disclosure relates to a field of an artificial intelligence technology such as augmented reality, deep learning and image processing, in particular to a field of a face reconstruction, more specifically to a method of processing an image, an electronic device and a storage medium for a face reconstruction.

### BACKGROUND

A common 3D reconstructed face has a smooth surface and a detail information of a face may not be reflected. This is because in a general reconstruction method (e.g., Blendshape), a linear model is used for the face reconstruction. In fact, however, a face is a nonlinear model and a face surface is uneven, but this kind of detail information may not be reflected through a texture map and an unevenness of detail is reflected from a shape. Alternatively, a bone driving-based method may be adopted, which needs to pre-establish a connection relationship between a bone point and a local 3D point, and achieve a deformation of the face from an average face by driving the bone point to reconstruct a new face.

### SUMMARY

The present disclosure provides a method of processing an image, an electronic device and a storage medium for a face reconstruction.

According to an aspect of the present disclosure, there is provided a method of processing an image, including: determining a shape parameter, a texture parameter and a static wrinkle parameter for an object according to an input image; reconstructing a coarse reconstructed shape for the object by using the shape parameter, and computing a coarse reconstructed texture map for the object by using the texture parameter; determining a fine reconstructed shape and a fine reconstructed texture map according to the static wrinkle parameter, the shape parameter and the texture parameter; and performing a rendering process based on the coarse reconstructed shape, the coarse reconstructed texture map, the fine reconstructed shape and the fine reconstructed texture map, so as to obtain a coarse reconstructed image and a fine reconstructed image for the input image.

According to an aspect of the present disclosure, there is provided an electronic device, including: at least one processor; and a memory communicatively connected to the at least one processor, wherein the memory stores instructions executable by the at least one processor, and the instructions, when executed by the at least one processor, cause the at least one processor to implement the method of processing the image as described in the present disclosure.

According to an aspect of the present disclosure, there is provided a non-transitory computer-readable storage medium having computer instructions stored thereon, wherein the computer instructions allow a computer to implement the method of processing the image as described in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure.

FIG. 1A shows a schematic flowchart of a method of processing an image for a face reconstruction according to an exemplary embodiment of the present disclosure.

FIG. 1B shows a schematic diagram of an example of a method of processing an image for a face reconstruction according to an exemplary embodiment of the present disclosure.

FIG. 2 shows a schematic flowchart of a method of processing an image for a face reconstruction according to another exemplary embodiment of the present disclosure.

FIG. 3 shows a schematic block diagram of an apparatus of processing an image according to an exemplary embodiment of the present disclosure.

FIG. 4 shows an effect diagram of a coarse reconstruction result and a fine reconstruction result according to an exemplary embodiment of the present disclosure.

FIG. 5 shows a schematic block diagram of an exemplary electronic device according to an exemplary embodiment of the present disclosure.

### DETAILED DESCRIPTION OF EMBODIMENTS

The following describes exemplary embodiments of the present disclosure with reference to the accompanying drawings, which include various details of embodiments of the present disclosure to facilitate understanding, and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The exemplary embodiments of the present disclosure achieve a face detail reconstruction, specifically including a coarse reconstruction and a fine reconstruction, by considering a wrinkle feature of a face. According to the exemplary embodiments of the present disclosure, the coarse reconstruction may be implemented to predict a shape parameter and a texture parameter of the face by using a multilayer neural network (e.g., a convolutional neural network (CNN)) as an encoder. The shape parameter may include, for example, a parameter about a pose and an expression of the face, which may be used to reconstruct a coarse reconstructed shape for the face. The texture parameter may include, for example, an illumination parameter, an albedo parameter and an image acquisition device (e.g., camera) parameter, which may be used to compute a coarse reconstructed texture map for the face. In addition, according to the exemplary embodiments of the present disclosure, the fine reconstruction may be implemented to predict a static wrinkle parameter for the face by using another CNN as an encoder, and predict a texture map containing a wrinkle information (i.e., a fine reconstructed texture map) and a shape containing the wrinkle information (i.e., a fine reconstructed shape) according to the static wrinkle parameter as well as the shape parameter and the texture parameter predicted by the coarse reconstruction. Then, a rendering process may be performed based on the coarse reconstructed shape and texture map and the fine reconstructed shape and texture map, so as to obtain a coarse reconstruction result and a fine reconstruction result.

Therefore, the face reconstruction according to the exemplary embodiments of the present disclosure may achieve an end-to-end network structure including reconstruction and rendering, output both the coarse reconstruction result and the fine reconstruction result containing the wrinkle detail information, and obtain a realistic face through rendering, so that a better reconstruction effect may be achieved.

It should be noted that the face reconstruction in embodiments of the present disclosure is not performed on a face model for a specific user, and may not reflect a personal information of a specific user.

A method of processing an image and a method of processing an image for a face reconstruction according to the exemplary embodiments of the present disclosure will be described in detail below with reference to the accompanying drawings. An object described below refers to a face. In addition, throughout the accompanying drawings, the same or similar elements or operations are represented by the same or similar reference numerals.

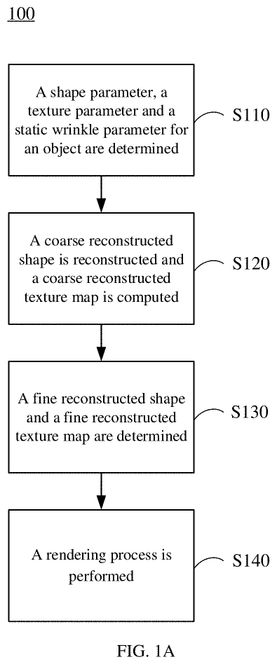

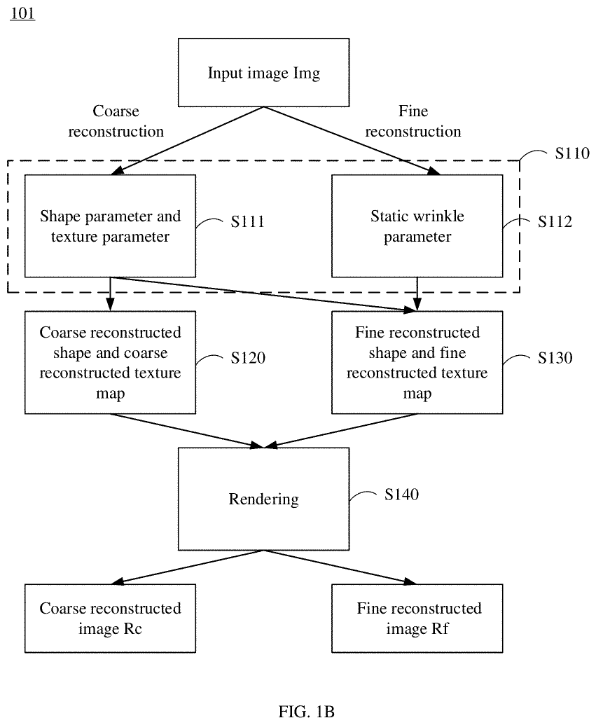

FIG. 1A shows a schematic flowchart of a method of processing an image for a face reconstruction according to an exemplary embodiment of the present disclosure.

It should be noted that in embodiments of the present disclosure, a subject of execution of the face reconstruction method may acquire a target two-dimensional (2D) face image through various public, legal and compliant methods. For example, the target 2D face image may be acquired from a public dataset, or acquired from a user with the user's authorization.

As shown in FIG. 1A, a method 100 of processing an image for a face reconstruction according to the exemplary embodiment of the present disclosure may include the following steps.

In step S110, a shape parameter, a texture parameter and a static wrinkle parameter for an object are determined according to an input image.

In step S120, a coarse reconstructed shape for the object is reconstructed using the shape parameter, and a coarse reconstructed texture map for the object is computed using the texture parameter.

In step S130, a fine reconstructed shape and a fine reconstructed texture map are determined according to the static wrinkle parameter, the shape parameter and the texture parameter.

In step S140, a rendering process is performed based on the coarse reconstructed shape, the coarse reconstructed texture map, the fine reconstructed shape and the fine reconstructed texture map, so as to obtain a coarse reconstructed image and a fine reconstructed image for the input image.

FIG. 1B shows a schematic diagram of an example of a method of processing an image for a face reconstruction according to an exemplary embodiment of the present disclosure. Hereinafter, a method 101 of processing an image for a face reconstruction according to an embodiment of the present disclosure will be described in detail with reference to FIG. 1B.

As shown in FIG. 1B, a left branch indicates a coarse reconstruction process, and a right branch represents a fine reconstruction process.

In step S110, a shape parameter, a texture parameter and a static wrinkle parameter for an object (i.e., a face) may be determined according to an input image Img. According to an exemplary embodiment of the present disclosure, the input image Img may be a single 2D image containing a face. The 2D face image in this embodiment may come from a public dataset, or an acquisition of the 2D face image is authorized by a user corresponding to the face image.

According to an exemplary embodiment of the present disclosure, step S110 may include sub-steps S111 and S112. In sub-step S111, a first CNN may be used to process the input image Img to obtain the shape parameter and the texture parameter. According to an exemplary embodiment of the present disclosure, the shape parameter may include a pose parameter (Pose) and an expression parameter (Exp) for the object, and the texture parameter may include an illumination parameter (Illuminate), an albedo parameter (Albedo) and an image acquisition device (e.g., camera) parameter.

In addition, in sub-step S112, a second CNN may be used to process the input image Img to obtain the static wrinkle parameter. According to an exemplary embodiment of the present disclosure, the static wrinkle parameter may indicate a static feature-based wrinkle (i.e., a wrinkle inherent to the object), for example, a wrinkle that appears with age. In addition, a wrinkle due to pose or expression may be described as a dynamic feature-based wrinkle. The static feature-based wrinkle and the dynamic feature-based wrinkle may be combined as a complete wrinkle feature of the object.

In step S120, a coarse reconstructed shape for the object may be reconstructed using the shape parameter, and a coarse reconstructed texture map for the object may be computed using the texture parameter.

According to an exemplary embodiment of the present disclosure, the coarse reconstructed shape may be obtained by inputting the shape parameter including the pose parameter and the expression parameter into a predetermined reconstruction model. The predetermined reconstruction model may include, for example, a Flame reconstruction model or a 3DMM reconstruction model, but the present disclosure is not limited thereto.

In addition, according to an exemplary embodiment of the present disclosure, the coarse reconstructed texture map may be obtained according to the texture parameter including the illumination parameter, the albedo parameter and the image acquisition device parameter by performing a normal mapping. However, the present disclosure is not limited thereto.

In step S130, a fine reconstructed shape and a fine reconstructed texture map may be determined according to the static wrinkle parameter, the shape parameter and the texture parameter.

According to an exemplary embodiment of the present disclosure, an offset map for the coarse reconstructed texture map may be determined according to the static wrinkle parameter and the shape parameter, and the fine reconstructed texture map may be determined according to the offset map and the coarse reconstructed texture map. The offset map may indicate a pixel offset of the texture map and may have the same size as the texture map. As an example, the offset map and the coarse reconstructed texture map may be combined to obtain the fine reconstructed texture map containing a wrinkle.

In addition, according to an exemplary embodiment of the present disclosure, the fine reconstructed shape may be obtained by performing an interpolation on the coarse reconstructed shape to obtain an interpolated coarse reconstructed shape and combining the obtained fine reconstructed texture map with the interpolated coarse reconstructed shape. The coarse reconstructed shape and the fine reconstructed shape may be in a form of a mesh (e.g., 3D-mesh). As an example, an interpolation may be performed to augment 3D points of a coarse reconstructed mesh to obtain a fine reconstructed mesh containing more 3D points, and then the fine reconstructed shape may be obtained by combining the fine reconstructed texture map containing the wrinkle with the fine reconstructed mesh (for example, by performing a mapping process), so as to achieve a better reconstruction effect and obtain a realistic face image.

In step S140, a rendering process may be performed based on the coarse reconstructed shape, the coarse reconstructed texture map, the fine reconstructed shape and the fine reconstructed texture map, so as to obtain a coarse reconstructed image Rc and a fine reconstructed image Rf for the input image Img. According to an exemplary embodiment of the present disclosure, the coarse reconstructed image Rc and the fine reconstructed image Rf may be reconstructed and rendered 2D face images, respectively.

According to an exemplary embodiment of the present disclosure, the rendering process may be performed by inputting the coarse reconstructed shape and the coarse reconstructed texture map as well as the fine reconstructed shape and the fine reconstructed texture map into a predetermined renderer to output the coarse reconstructed image Rc and the fine reconstructed image Rf. The predetermined renderer may be a differentiable renderer, such as a pytorch3d renderer. However, the present disclosure is not limited thereto.

It should be noted that the reconstructed face image (coarse reconstructed image and fine reconstructed image) obtained according to an embodiment of the present disclosure contains a user face information indicated by the input 2D face image, but the reconstruction of the face image is performed with the user's authorization, and a reconstruction process complies with relevant laws and regulations.

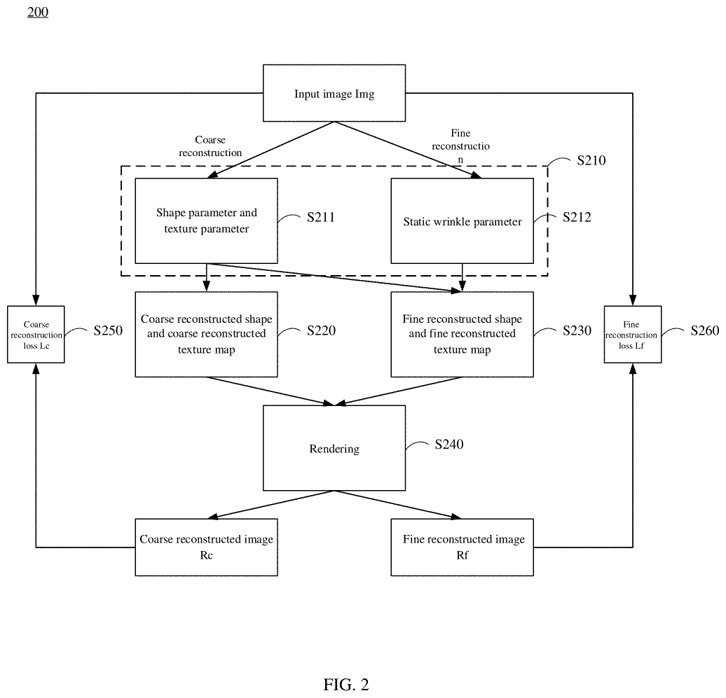

FIG. 2 shows a schematic block diagram of a method of processing an image for a face reconstruction according to another exemplary embodiment of the present disclosure. The above description with reference to FIG. 1A and FIG. 1B is also applicable to FIG. 2. Accordingly, a repetitive description will be omitted for the sake of brevity.

As shown in FIG. 2, a method 200 of processing an image for a face reconstruction according to another exemplary embodiment of the present disclosure may include the steps described below, where a left branch indicates a coarse reconstruction process and a right branch indicates a fine reconstruction process. Step S210 (including sub-steps S211 and S212) to step S240 are the same as step S110 to step S140 shown in FIG. 1B, and thus a description thereof will be omitted here. A difference between the embodiment shown in FIG. 2 and the embodiment shown in FIG. 1B will be mainly described.

In FIG. 2, according to an exemplary embodiment of the present disclosure, a coarse reconstruction loss Lc may be calculated in step S250 according to the input image Img and the coarse reconstructed image Rc, and a fine reconstruction loss Lf may be calculated in step S260 according to the input image Img and the fine reconstructed image Rf. As an example, the coarse reconstruction loss Lc and the fine reconstruction loss Lf may be an L1 norm loss (L1 loss) or a mean absolute error (MAE). However, the present disclosure is not limited thereto.

According to an exemplary embodiment of the present disclosure, the coarse reconstruction loss Lc may be calculated for a face region in the input image Img and a face region in the coarse reconstructed image Rc, and the fine reconstruction loss Lf may be calculated for the face region in the input image Img and a face region in the fine reconstructed image Rf. As an example, the face region may be obtained by applying a mask.

According to an exemplary embodiment of the present disclosure, the coarse reconstruction loss Lc and the fine reconstruction loss Lf may be used to perform an iterative optimization (e.g., training or parameter-adjustment) on the first CNN and the second CNN to obtain more accurate shape parameter, texture parameter and static wrinkle parameter, so that more accurate coarse reconstruction and fine reconstruction may be performed and a better reconstruction result may be obtained.

The method of processing the image according to the exemplary embodiments of the present disclosure may further include performing a preprocessing operation on the input image. For example, the preprocessing may be performed on the input image Img prior to determining the shape parameter, the texture parameter and the static wrinkle parameter. According to an example, the preprocessing may include at least one of a face recognition and an image registration. After that, the preprocessed input image may be input into the first CNN and the second CNN respectively to obtain the shape parameter, the texture parameter and the static wrinkle parameter for the face, and used to perform subsequent processing.

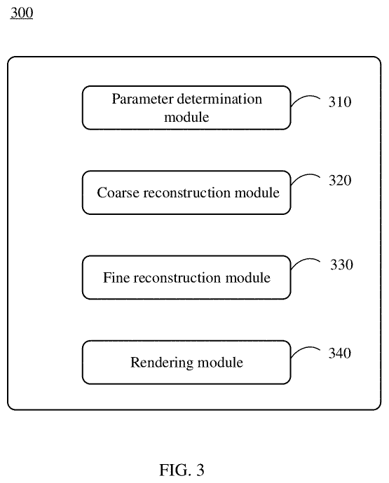

FIG. 3 shows a schematic block diagram of an apparatus of processing an image according to an exemplary embodiment of the present disclosure. The above description with reference to FIG. 1A, FIG. 1B and FIG. 2 is also applicable to FIG. 3. Accordingly, a repetitive description will be omitted for the sake of brevity. In particular, according to an exemplary embodiment of the present disclosure, an apparatus 300 of processing an image shown in FIG. 3 may be configured to perform the method 100, 101 or 200 of processing the image shown in FIG. 1A, FIG. 1B or FIG. 2 to perform the face reconstruction.

As shown in FIG. 3, the apparatus 300 of processing the image according to the exemplary embodiment of the present disclosure may include a parameter determination module 310, a coarse reconstruction module 320, a fine reconstruction module 330, and a rendering module 340.

In an exemplary embodiment of the present disclosure, the parameter determination module 310 may be used to determine a shape parameter, a texture parameter and a static wrinkle parameter for an object according to an input image. The coarse reconstruction module 320 may be used to reconstruct a coarse reconstructed shape for the object by using the shape parameter and compute a coarse reconstructed texture map for the object by using the texture parameter. The fine reconstruction module 330 may be used to determine a fine reconstructed shape and a fine reconstructed texture map according to the static wrinkle parameter, the shape parameter and the texture parameter. The rendering module 340 may be used to perform a rendering process based on the coarse reconstructed shape, the coarse reconstructed texture map, the fine reconstructed shape and the fine reconstructed texture map, so as to obtain a coarse reconstructed image and a fine reconstructed image for the input image.

According to an exemplary embodiment of the present disclosure, the fine reconstruction module 330 may include: an offset map determination unit used to determine an offset map for the coarse reconstructed texture map according to the static wrinkle parameter and the shape parameter; a fine reconstructed texture map determination unit used to determine the fine reconstructed texture map according to the offset map and the coarse reconstructed texture map; and a fine reconstructed shape obtaining unit used to obtain the fine reconstructed shape by performing an interpolation on the coarse reconstructed shape to obtain an interpolated coarse reconstructed shape and combining the fine reconstructed texture map with the interpolated coarse reconstructed shape.

In addition, according to an exemplary embodiment of the present disclosure, the parameter determination module 310 may include: a shape and texture parameter determination unit used to process the input image by using a first convolutional neural network, so as to determine the shape parameter and the texture parameter; and a static wrinkle parameter determination unit used to process the input image by using a second convolution neural network, so as to determine the static wrinkle parameter.

In addition, according to an exemplary embodiment of the present disclosure, the coarse reconstruction module 320 may include: a coarse reconstructed shape obtaining unit used to input the shape parameter into a predetermined reconstruction model to obtain the coarse reconstructed shape; and a coarse reconstructed texture map obtaining unit used to obtain the coarse reconstructed texture map according to the texture parameter by performing a normal mapping.

In addition, in the exemplary embodiment of the present disclosure, the apparatus 300 of processing the image may further include a preprocessing module used to perform at least one of an object recognition and an image registration on the input image prior to determining the shape parameter, the texture parameter and the static wrinkle parameter.

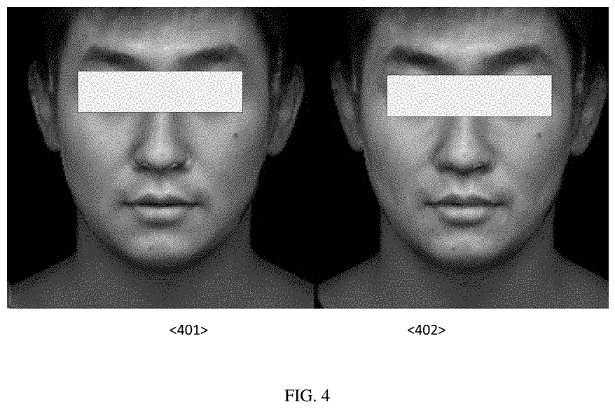

FIG. 4 shows an effect diagram of a coarse reconstruction result and a fine reconstruction result according to an exemplary embodiment of the present disclosure.

As shown in FIG. 4, 401 represents a coarse reconstructed image Rc, and 402 represents a fine reconstructed image Rf. As shown, compared with the coarse reconstructed image Rc 401, the fine reconstructed image Rf 402 contains more details of facial wrinkles and has a better reconstruction effect.

In addition, according to the exemplary embodiments of the present disclosure, the present disclosure further provides an electronic device, a readable storage medium, and a computer program product.

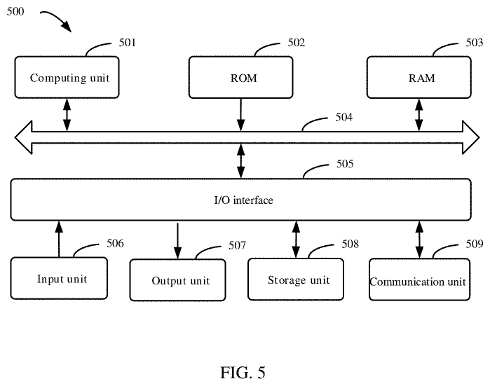

FIG. 5 shows a schematic block diagram of an exemplary electronic device 500 for implementing the exemplary embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the device 500 includes a computing unit 501 which may perform various appropriate actions and processes according to a computer program stored in a read only memory (ROM) 502 or a computer program loaded from a storage unit 508 into a random access memory (RAM) 503. In the RAM 503, various programs and data necessary for an operation of the device 500 may also be stored. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, such as a keyboard, or a mouse; an output unit 507, such as displays or speakers of various types; a storage unit 508, such as a disk, or an optical disc; and a communication unit 509, such as a network card, a modem, or a wireless communication transceiver. The communication unit 509 allows the device 500 to exchange information/data with other devices through a computer network such as Internet and/or various telecommunication networks.

The computing unit 501 may be various general-purpose and/or a dedicated processing assemblies having processing and computing capabilities. Some examples of the computing units 501 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 501 executes various methods and processing described above, such as the methods and processing executed by the apparatus 300 as described above. For example, in embodiments, the above methods may be implemented as a computer software program which is tangibly embodied in a machine-readable medium, such as the storage unit 508. In embodiments, the computer program may be partially or entirely loaded and/or installed in the device 500 via the ROM 502 and/or the communication unit 509. The computer program, when loaded in the RAM 503 and executed by the computing unit 501, may execute one or more steps in the method 100, 101 or 200 described above. Alternatively, in other embodiments, the computing unit 501 may be configured to execute the method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a load programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

In the technical solution of the present disclosure, an acquisition, a storage and an application of the user's personal information involved are in compliance with the provisions of relevant laws and regulations, and do not violate public order and good customs.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an image, the method comprising:
determining a shape parameter, a texture parameter and a static wrinkle parameter for an object according to an input image;
reconstructing a coarse reconstructed shape for the object by using the shape parameter, and computing a coarse reconstructed texture map for the object by using the texture parameter;
determining a fine reconstructed shape and a fine reconstructed texture map according to the static wrinkle parameter, the shape parameter and the texture parameter; and
performing a rendering process based on the coarse reconstructed shape, the coarse reconstructed texture map, the fine reconstructed shape and the fine reconstructed texture map, so as to obtain a coarse reconstructed image and a fine reconstructed image for the input image.

2. The method of claim 1, wherein the shape parameter comprises a pose parameter and an expression parameter, and the texture parameter comprises an illumination parameter, an albedo parameter and an image acquisition device parameter.

3. The method of claim 1, wherein the determining a fine reconstructed shape and a fine reconstructed texture map comprises:
determining an offset map for the coarse reconstructed texture map according to the static wrinkle parameter and the shape parameter;
determining the fine reconstructed texture map according to the offset map and the coarse reconstructed texture map; and
determining the fine reconstructed shape by performing an interpolation on the coarse reconstructed shape to obtain an interpolated coarse reconstructed shape and combining the fine reconstructed texture map with the interpolated coarse reconstructed shape.

4. The method of claim 1, wherein the determining a shape parameter, a texture parameter and a static wrinkle parameter for an object comprises processing the input image by using a first convolutional neural network, so as to determine the shape parameter and the texture parameter.

5. The method of claim 4, wherein the determining a shape parameter, a texture parameter and a static wrinkle parameter for an object further comprises processing the input image by using a second convolutional neural network, so as to determine the static wrinkle parameter.

6. The method of claim 1, further comprising, prior to determining the shape parameter, the texture parameter and the static wrinkle parameter, performing an object recognition and/or an image registration, on the input image.

7. The method of claim 1, wherein the reconstructing a coarse reconstructed shape for the object by using the shape parameter comprises inputting the shape parameter into a reconstruction model, so as to obtain the coarse reconstructed shape.

8. The method of claim 1, wherein the computing a coarse reconstructed texture map for the object by using the texture parameter comprises computing the coarse reconstructed texture map according to the texture parameter by performing a normal mapping.

9. An electronic device, comprising:
at least one processor; and
a memory communicatively connected to the at least one processor, wherein the memory stores instructions executable by the at least one processor, the instructions, when executed by the at least one processor, configured to cause the at least one processor to at least:
determine a shape parameter, a texture parameter and a static wrinkle parameter for an object according to an input image;
reconstruct a coarse reconstructed shape for the object by using the shape parameter, and compute a coarse reconstructed texture map for the object by using the texture parameter;
determine a fine reconstructed shape and a fine reconstructed texture map according to the static wrinkle parameter, the shape parameter and the texture parameter; and
perform a rendering process based on the coarse reconstructed shape, the coarse reconstructed texture map, the fine reconstructed shape and the fine reconstructed texture map, so as to obtain a coarse reconstructed image and a fine reconstructed image for the input image.

10. The electronic device of claim 9, wherein the shape parameter comprises a pose parameter and an expression parameter, and the texture parameter comprises an illumination parameter, an albedo parameter and an image acquisition device parameter.

11. The electronic device of claim 9, wherein the instructions, when executed by the at least one processor, are configured to cause the at least one processor to:
determine an offset map for the coarse reconstructed texture map according to the static wrinkle parameter and the shape parameter;
determine the fine reconstructed texture map according to the offset map and the coarse reconstructed texture map; and
determine the fine reconstructed shape by performance of an interpolation on the coarse reconstructed shape to obtain an interpolated coarse reconstructed shape and combine the fine reconstructed texture map with the interpolated coarse reconstructed shape.

12. The electronic device of claim 9, wherein the instructions, when executed by the at least one processor, cause the at least one processor to process the input image by using a first convolutional neural network, so as to determine the shape parameter and the texture parameter.

13. The electronic device of claim 12, wherein the instructions, when executed by the at least one processor, are configured to cause the at least one processor to process the input image by using a second convolutional neural network, so as to determine the static wrinkle parameter.

14. The electronic device of claim 9, wherein the instructions, when executed by the at least one processor, are configured to cause the at least one processor to perform an object recognition and/or an image registration, on the input image.

15. The electronic device of claim 9, wherein the instructions configured to cause the at least processor to reconstruct a coarse reconstructed shape for the object by using the shape parameter are further configured to cause the at least processor to input the shape parameter into a predetermined reconstruction model, so as to obtain the coarse reconstructed shape.

16. The electronic device of claim 9, wherein the instructions, when executed by the at least one processor, are further configured to cause the at least one processor to compute the coarse reconstructed texture map according to the texture parameter by performing a normal mapping.

17. A non-transitory computer-readable storage medium having computer instructions therein, the computer instructions, when executed by a computer system, configured to cause the computer system to at least:
determine a shape parameter, a texture parameter and a static wrinkle parameter for an object according to an input image;
reconstruct a coarse reconstructed shape for the object by using the shape parameter, and compute a coarse reconstructed texture map for the object by using the texture parameter;
determine a fine reconstructed shape and a fine reconstructed texture map according to the static wrinkle parameter, the shape parameter and the texture parameter; and
perform a rendering process based on the coarse reconstructed shape, the coarse reconstructed texture map, the fine reconstructed shape and the fine reconstructed texture map, so as to obtain a coarse reconstructed image and a fine reconstructed image for the input image.

18. The storage medium of claim 17, wherein the computer instructions are further configured to cause the computer system to:
determine an offset map for the coarse reconstructed texture map according to the static wrinkle parameter and the shape parameter;
determine the fine reconstructed texture map according to the offset map and the coarse reconstructed texture map; and
determine the fine reconstructed shape by performing an interpolation on the coarse reconstructed shape to obtain an interpolated coarse reconstructed shape and combining the fine reconstructed texture map with the interpolated coarse reconstructed shape.

19. The storage medium of claim 17, wherein the computer instructions are further configured to cause the computer system to compute the coarse reconstructed texture map according to the texture parameter by performing a normal mapping.

20. The storage medium of claim 17, wherein the computer instructions are further configured to cause the computer system to:
process the input image by using a first convolutional neural network, so as to determine the shape parameter and the texture parameter; and
process the input image by using a second convolutional neural network, so as to determine the static wrinkle parameter.
